(19) United States
(12) Patent Application Publication
(10) Pub. No.: US 2014/0256168 A1
(43) Pub. Date: Sep. 11, 2014

(54) FEMALE TERMINAL

(71) Applicant: Yazaki Corporation, Tokyo (JP)

(72) Inventor: Shinji Kodama, Makinohara-shi (JP)

(73) Assignee: Yazaki Corporation, Tokyo (JP)

(21) Appl. No.: 14/356,278

(22) PCT Filed: Nov. 21, 2012
(86) PCT No.: PCT/JP2012/080809

§ 371 Date: May 5, 2014

(30) Foreign Application Priority Data
Nov. 22, 2011 (JP) 2011-255343

(51) Int. Cl. H01R 13/52

(52) U.S. Cl. CPC H01R 13/5216
USPC 439/283

(57) ABSTRACT

A female terminal includes: an electrical connection part in a tubular shape which includes a distal end opening adapted to receive a contact part of a male terminal; a wire connecting part which is continuously provided at an opposite side to the distal end opening of the electrical connection part; a contact part which is provided at an inside of the electrical connection part, and which is adapted to be in contact with the contact part of the male terminal, and an insulating infilling body in a gel form which is filled the inside of the electrical connection part, and which covers an outside of the electrical connection part.

### TECHNICAL FIELD

The present invention relates to a female terminal.

### BACKGROUND ART

An insulating covering at a tip end of a covered wire is peeled off to expose a conductor, in some cases, so that the covered wire can be connected to an electrical appliance or a device by way of a terminal which is crimped to this exposed conductor. In case where the conductor which has been crimped to the terminal is left as it is, there is such an inconvenience that water content penetrates into the conductor, and intrudes into the covered wire due to capillary phenomenon. For the purpose of preventing this inconvenience, various waterproofing treatments are applied to an end connecting part including the conductor itself (refer to PTL 1, for example).

For example, as shown in FIG. 5, an end connecting part of a covered wire 501 is covered with a mold resin 503 into a shape of a spindle, and the resin is difficult to be peeled off, when the covered wire 501 is bent in this part. One side of a mold part 507 of a molding die 505 is blocked with upper and lower elastic blocking plates 509 which are opposed to each other, and then, the end connecting part is set in the mold part 507 in such a manner that apart of the covered wire 501 extending backward from the one side of the mold part 507 is elastically clamped between the elastic blocking plates 509 from above and below. In this state, a mold resin 503 in a molten state is injected into the mold part 507 thereby to cover substantially all over the end connecting part by molding.

### CITATION LIST

### Patent Literature

[PTL 1] JP-A-2001-167640

### SUMMARY OF INVENTION

### Technical Problem

However, the end connecting part of the related-art covered wire 501 is covered by molding with the mold resin 503 substantially all over the end connecting part, using the molding die 505. Moreover, it is necessary to secure a resin intrusion preventing area 513 for preventing leak of the mold resin 503 to a tab-shaped contact piece (an electrical contact part) 511. For this reason, an area covered with the resin must be strictly managed, and at the same time, a large-scale installation such as the molding die 505 for injecting the mold resin 503 is required.

Moreover, in the related-art end connecting part, a naked conductor 515 and a crimpling part 517 are covered with the mold rein 503, and hence, the water is prevented from intruding into the covered wire through the naked conductor 515 due to the capillary phenomenon.

By the way, a resin of humidity setting type, specifically, polyurethane hot melt is used as a molding compound for the related-art mold resin 503. Therefore, in case where the mold resin 503 is adhered to the tab-shaped contact piece 511, a work for scraping it off is required, and in case where the tab-shaped contact piece 511 is covered with the resin, electrical connection with a mating female terminal cannot be achieved.

Further, in the tab-shaped contact piece 511 formed of copper or aluminum which is not covered with the mold resin 503, corrosion may occur with intruded water, frosted water, or the like, in some cases. For example, an oxidized covering which is formed by oxidizing a surface of aluminum is very thin, less than about 100 Å, but dense, hard, and insulating. Therefore, electrical resistance of the oxidized covering is large. For this reason, in case where corrosion has occurred in a contact part between the mating female terminal and the tab-shaped contact piece 511, there has been such possibility that it becomes difficult to maintain a favorably electrical continuity.

The invention has been made in view of the above described circumstances, and an object of the invention is to provide a female terminal in which a resin covered area need not be strictly managed, and waterproofing and corrosion preventing works can be applied employing a simple installation.

### Solution to Problem

According to the invention, there is provided a female terminal comprising: an electrical connection part in a tubular shape which includes a distal end opening adapted to receive a contact part of a male terminal; a wire connecting part which is continuously provided at an opposite side to the distal end opening of the electrical connection part; a contact part which is provided at an inside of the electrical connection part, and which is adapted to be in contact with the contact part of the male terminal, and an insulating infilling body in a gel form which is filled the inside of the electrical connection part, and which covers an outside of the electrical connection part.

The insulating infilling body may be a water absorbing gel.

The contact part which is adapted to be in contact with the contact part of the male terminal may include a spring part.

The insulating infilling body may cover at least the contact part which is adapted to be in contact with the contact part of the male terminal, in the electrical connection part.

The insulating infilling body may cover an outer face of the electrical connection part.

### Advantageous Effects of Invention

According to an aspect of the invention, when the electrical contact part of the male terminal enters into the distal end opening of the electrical connection part, the electrical contact part of the male terminal intrudes into the insulating infilling body in a gel form. The insulating infilling body is tightly fitted to an outer peripheral face of the electrical contact part of the male terminal which has entered, and a gap for allowing intrusion of water will not occur between the outer peripheral face and the insulating infilling body. When engagement between the two terminals proceeds, a distal end part of the electrical contact part which has advanced in the insulating infilling body comes into contact with the spring part. Then, the insulating infilling body which has been adhered to a surface of the spring part is scraped off by the distal end part of the electrical contact part. As the results, the electrical contact part is brought into contact with the surface of the spring part, and electrical connection will not be lost. A contact part between the female terminal and the male terminal is completely sealed inside the insulating infilling body, and will not be exposed to water from the exterior or frosted water which is generated by intrusion of humidity. Accordingly, it is possible to prevent intrusion of water into the covered wire from the contact part between the female terminal and the male terminal, and at the same time, it is possible to prevent corrosion of the contact part for a long period thereby to maintain a favorable electrical continuity. The insulating infilling body can be easily attached to and filled in the electrical connection part, without using a molding die.

According to an aspect of the invention, the insulating infilling body is formed of the water absorbing gel having a mesh-like structure containing high polymer, and has water absorbing capacity. Therefore, even though the insulating infilling body is insufficiently filled in the electrical connection part, water can be absorbed in the gel, in case of a small amount of water. As the results, intrusion of the water into the contact part, and corrosion of the contact part can be more effectively prevented.

According to an aspect of the invention, the resin covered area need not be strictly managed, and the waterproofing and corrosion preventing works can be applied employing a simple installation.

### BRIEF DESCRIPTION OF DRAWINGS

FIG. 1A is a side view of a female terminal in an embodiment according to the invention.

FIG. 1B is a longitudinal sectional view of the female terminal as shown in FIG. 1A.

FIG. 2 is a perspective view showing an entirety of a female terminal body, before an insulating infilling body of the female terminal as shown in FIGS. 1A and 1B is provided.

FIG. 3 is a sectional side view for describing a manner of covering and filling the female terminal body as shown in FIG. 2 with the insulating infilling body by overall soaking.

FIG. 4 is a longitudinal sectional view showing a state where an electrical contact part of a male terminal is inserted into the female terminal in which an electrical connection part is provided with the insulating infilling body.

FIG. 5 is a sectional side view showing a state where an end connecting part of a related-art terminal is set in a mold part of a molding die.

### DESCRIPTION OF EMBODIMENTS

Now, an embodiment according to the invention will be described referring to the drawings.

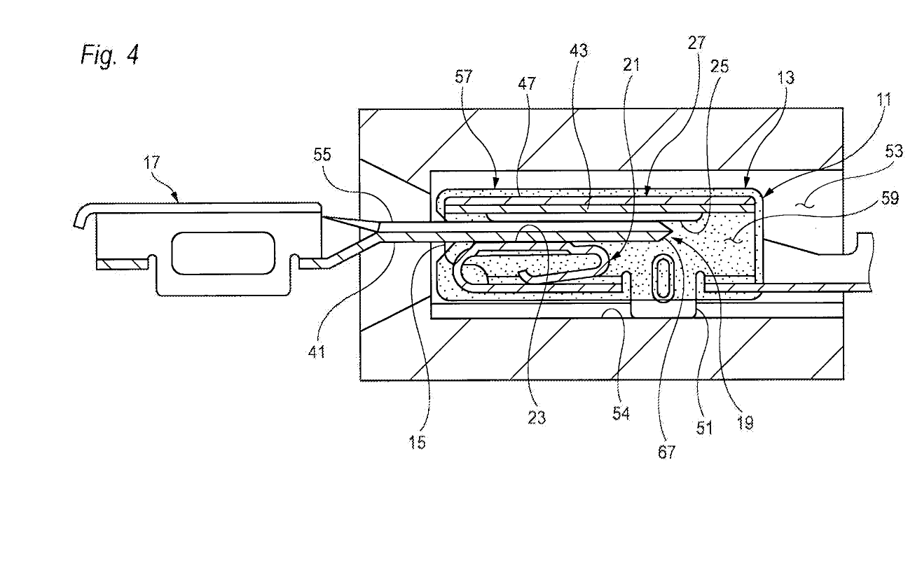

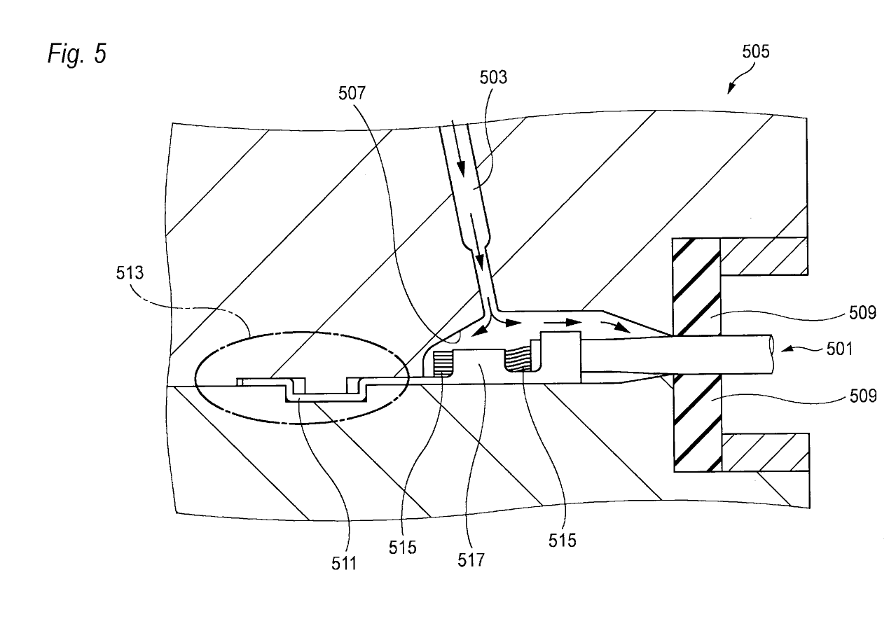

A female terminal 11 in this embodiment includes a female terminal body 27 to be electrically connected to a male terminal 17 (See FIG. 4) which is inserted from a distal end opening 15 of an electrical connection part 13 in a shape of a rectangular tube. In this embodiment, the male terminal 17 is of a tab type having a tab-shaped contact piece (an electrical contact part) 19. However, the male terminal 17 may be, for example, of a square pin type, a round pin type, etc.

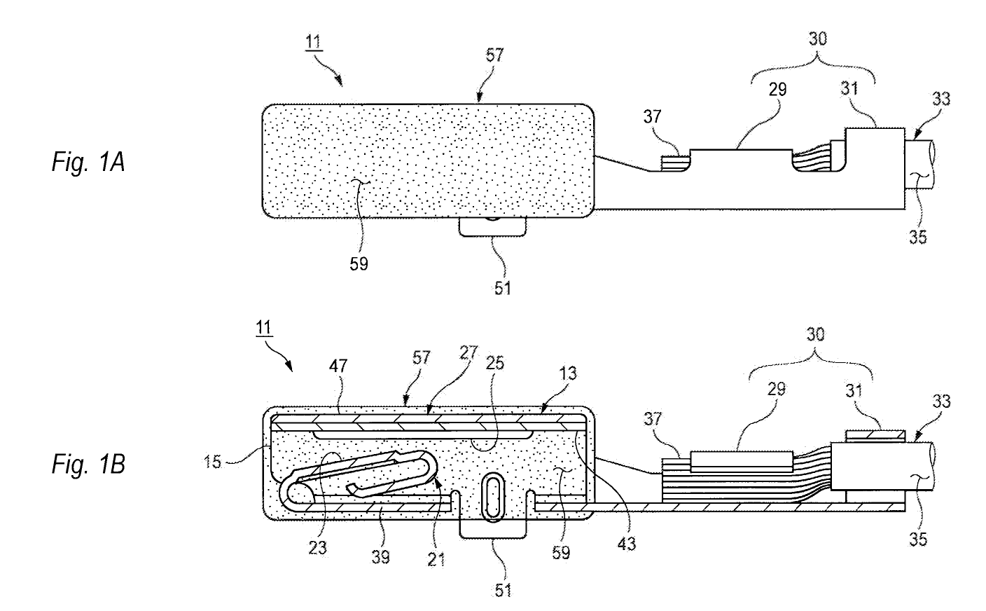

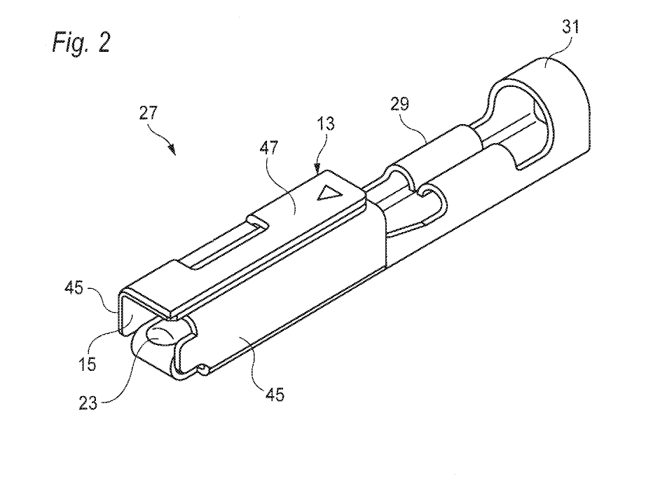

As shown in FIGS. 1A to 2, respective parts of the female terminal body 27 in this embodiment, which are shown in the drawings, are formed by applying stamping works and bending works to a same developed material, which is formed of a conductive metal plate. It is to be noted that in this specification, an insertion side of the male terminal 17 is referred to as “a front side”, and an opposite side thereto is referred to as “a rear side” in describing the female terminal body 27.

A wire connecting part 30 is continuously provided in rear of the electrical connection part 13 of the female terminal body 27. The wire connecting part 30 has a conductor crimping part 29 and an insulating covering crimping part 31. The conductor crimping part 29 fixes, by crimpling, a conductor 37 after a covering 35 is removed from a covered wire 33. The insulating covering crimping part 31 fixes, by crimpling, the covered wire 33 together with the covering 35.

The electrical connection part 13 has the distal end opening 15 for receiving the male terminal 17, at its front end. As shown in FIG. 1B, a spring part 21 whose base end is connected to a bottom wall 39 is provided inside the electrical connection part 13. The spring part 21 is folded in an e-shape in a sectional view, and its tip end part is a free end to be opposed to one of faces 41 of the male terminal 17 which has been inserted into the electrical connection part 13. The spring part 21 presses the tab-shaped contact piece 19 of the male terminal 17 which has been inserted from the distal end opening 15, against a top wall 43 which is one of inner walls of the electrical connection part 13 (See FIG. 4).

Side walls 45 are uprightly provided at both sides of the bottom wall 39. One of the side walls 45 is continued to the top wall 43, and the other side wall 45 is continued to an upper plate 47 which covers the top wall 43 from above. The one side wall 45 is provided with a hanging piece 51. When the female terminal body 27 is inserted into a terminal containing room 53 of a connector housing (See FIG. 4), the hanging piece 51 is engaged with a guide groove 54 to be guided for insertion.

As shown in FIG. 1B, the spring part 21 is provided with a spring side contact part 23, which is brought into contact with the one face 41 of the male terminal 17. In this embodiment, the spring side contact part 23 is formed as a projection in a semi-cylindrical shape of which a tubular buss-bar part extends in an insertion direction of the male terminal so that the spring side contact part 23 may be brought into linear contact with the one face 41 of the male terminal 17.

The top wall 43 is provided with a tube side contact part 25 inside the electrical connection part 13. The tube side contact part 25 is provided so as to be opposed to the spring part 21. This tube side contact part 25 is formed as a projection in a semi-cylindrical shape of which a tubular buss-bar part extends in the insertion direction of the male terminal so that the tube side contact part 25 may be brought into linear contact with the other face 55 of the male terminal 17.

The female terminal 11 in this embodiment employs an art of blocking a rear side of the terminal containing room 53 of the connector housing, in addition to the waterproofing and corrosion prevention of the female terminal body 27. Specifically, a rear part of the terminal containing room 53 is blocked with a rear cover, a waterproofing rubber plug or the like (not shown) for preventing intrusion of water from the terminal inserting side. Besides, the female terminal 11 has such a structure that water may not intrude into the conductor 37 and the conductor crimping part 29 from the electrical connection part 13 of the female terminal body 27.

Specifically, the female terminal 11 has an insulating infilling body 57 in a gel form which is provided in the electrical connection part 13. The insulating infilling body 57 is filled inside the electrical connection part 13 and also covers an outside of the electrical connection part 13. The insulating infilling body 57 is in a form of jelly at a room temperature, and softer than a related-art resin. Therefore, the insulating infilling body 57 is easily scraped off, when the male terminal 17 is inserted, even in case of a large fitting thickness.

The insulating infilling body 57 in this embodiment is formed of water absorbing gel 59. The water absorbing gel 59 is hydrophilic polymer having a cross-linkage structure, which has water absorbing power of ten times or more of its own weight, and water is hardly removed, even though pressurized. As the polymer having the cross-linkage structure, there are polymers of starch family and cellulose family obtained by graft polymerization or carboxymethylization, and synthetic polymers of polyacrylic salt family, polyvinyl alcohol family, polyacryloamide family, polyoxyethylene family, etc. For example, the polymer of polyacrylic sodium family is obtained by partially neutralizing acryl acid, and then, copolymerizing it with a cross-linkage monomer. Industrially, the polymer can be obtained by aqueous solution polymerizing method in which monomer aqueous solution is polymerized, and the obtained gel is fractionalized. The polymer having high water absorbing capacity which has been thus obtained has a three-dimensional mesh structure in a slight cross-linkage, and when a carboxyl group which is dispersed absorbs water, sodium ion is dissociated in the gel. As the results, the polymer having the high water absorbing capacity can absorb and keep pure water of 100 to 1000 times of its own weight, and physiological salt solution of 20 to 60 times of its own weight.

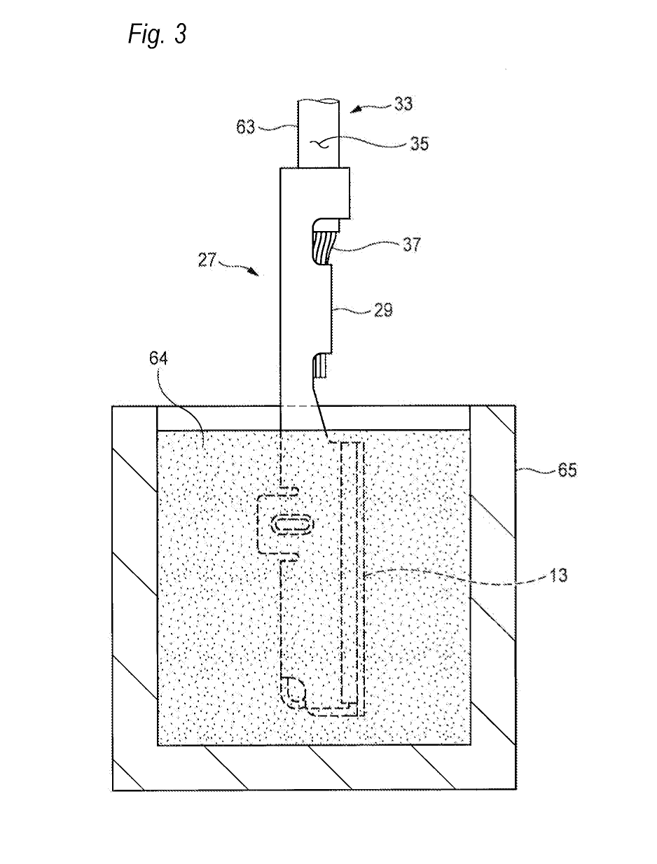

In order to form this insulating infilling body 57 in the female terminal body 27, as a first step, the conductor 37 of the covered wire 33 is crimped to the conductor crimping part 29 in advance, as shown in FIG. 3.

Then, the electrical connection part 13 of the female terminal body 27 which is connected to a lower end part 63 of the covered wire 33 which is suspended in a vertical direction is completely soaked in a water absorbing polymer tank 65 in which a polymer 64 having high water absorbing capacity in a molten state is contained. On this occasion, not only the electrical connection part 13, but also, an entirety of the female terminal body 27 including the wire connecting part 30 may be completely soaked in the water absorbing polymer tank 65.

Thereafter, by picking up the electrical connection part 13 which is soaked in the high water absorbing polymer 64, the high water absorbing polymer 64 is filled inside the electrical connection part 13, and also covers an outer peripheral face of the electrical connection part 13. In this manner, the insulating infilling body 57 can be obtained.

Then, operation of the female terminal 11 having the above described structure will be described.

In the female terminal 11 in this embodiment, when the tab-shaped contact piece 19 of the male terminal 17 enters into the distal end opening 15 of the electrical connection part 13, a tab tip end (a distal end part) 67 of the tab-shaped contact piece 19 enters into the insulating infilling body 57 in a gel form. The insulating infilling body 57 is tightly fitted to an outer peripheral face of the tab-shaped contact piece 19 which has entered, and a gap for allowing intrusion of water will not occur between the outer peripheral face and the insulating infilling body 57.

When engagement between the two terminals proceeds, and the tab tip end 67 of the tab-shaped contact piece 19 which has advanced in the insulating infilling body 57 comes into contact with the spring side contact part 23 and the tube side contact part 25, the insulating infilling body 57 which has been adhered to the surfaces of the spring side contact part 23 and the tube side contact part 25 is scraped off by the tab tip end 67. As the results, the tab-shaped contact piece 19 is brought into a clamped state, having the one face 41 thereof contacted with the spring side contact part 23, and having the other face 55 thereof contacted with the tube side contact part 25. Therefore, the electrical connection will not be lost.

The contact part between the female terminal 11 and the male terminal 17 is sealed inside the insulating infilling body 57, and will not be exposed to water from the exterior or frosted water which is generated by intrusion of humidity. Accordingly, it is possible to prevent intrusion of water into the covered wire 33 from the contact part between the female terminal 11 and the male terminal 17, and at the same time, it is possible to prevent corrosion of the contact part for a long period. In this manner, it becomes possible to maintain a favorable electrical continuity. The insulating infilling body 57 can be easily attached to and filled in the electrical connection part 13 of the female terminal body 27, without using a molding die.

The insulating infilling body 57 in this embodiment is formed of the water absorbing gel 59 having a mesh-like structure containing the high polymer, and has the water absorbing capacity. Therefore, even though the insulating infilling body 57 is insufficiently filled in the electrical connection part 13, water can be absorbed in the gel, in case of a small amount of water. As the results, intrusion of water and corrosion of the contact part can be more effectively prevented.

In order to form the insulting infilling body 57, by holding the covered wire 33 which is crimped to the wire connecting part 30 of the female terminal body 27, only the electrical connection part 13 is immersed in the high water absorbing polymer 64 in such a manner that the female terminal body 27 which is connected to the lower end part 63 is positioned at a lower side, and completely soaked in the water absorbing polymer tank 65. In this manner, it is possible to fill the water absorbing gel 59 inside the electrical connection part 13, and at the same time, to apply the covering 35 to the outer face of the electrical connection part 13, without requiring a large-scale installation.

Moreover, because the outer face of the electrical connection part 13 can be also covered with the insulating infilling body 57 by overall soaking, it is possible to prevent corrosion which may occur on the outer face of the electrical connection part 13, and to restrain spread of the corrosion inside the electrical connection part 13. As the results, highly sealed waterproofing performance and corrosion preventing performance can be obtained for a long time.

According to the female terminal 11 in this embodiment, the resin covered area need not be strictly managed, and the waterproofing and corrosion preventing works can be applied, employing a simple installation.

The female terminal according to the invention is not limited to the above described embodiment, but various modifications and improvements can be appropriately made. Moreover, materials, shapes, sizes, numbers, positions to be arranged, and so on of the constituent members in the above described embodiment are not limited, but optional, provided that the invention can be achieved.

For example, in the above described embodiment, the tab-shaped contact piece 19 of the male terminal 17 is so designed as to be clamped between the spring side contact part 23 of the spring part 21 and the tube side contact part 25 of the top wall 43. However, the tab-shaped contact piece 19 may have such a structure that it can be clamped by a pair of spring parts which are provided so as to be opposed to an inside of the electrical connection part 13.

The present application is based on Japanese Patent Application No. 2011-255343 filed on Nov. 22, 2011, the contents of which are incorporated herein by way of reference.

### INDUSTRIAL APPLICABILITY

According to the invention, there is provided a female terminal in which a resin covered area need not be strictly managed, and waterproofing and corrosion preventing works can be applied employing a simple installation.

### REFERENCE SIGNS LIST

11 Female terminal
13 Electrical connection part
15 Distal end opening
17 Male terminal
19 Tab-shaped contact piece (electrical contact part)
21 Spring part
23 Spring side contact part
25 Tube side contact part
27 Female terminal body
29 Conductor crimping part
30 Wire connecting part
33 Covered wire
37 Conductor
41 One face
55 Other face
57 Insulating infilling body
59 Water absorbing gel
63 Lower end part
64 Polymer having high water absorbing capacity
67 Tab tip end (distal end part)

1. A female terminal comprising:
an electrical connection part in a tubular shape which includes a distal end opening adapted to receive a contact part of a male terminal;
a wire connecting part which is continuously provided at an opposite side to the distal end opening of the electrical connection part;
a contact part which is provided at an inside of the electrical connection part, and which is adapted to be in contact with the contact part of the male terminal, and
an insulating infilling body in a gel form which is filled the inside of the electrical connection part, and which covers an outside of the electrical connection part.

2. The female terminal according to claim 1, wherein the insulating infilling body is a water absorbing gel.

3. The female terminal according to claim 1, wherein the contact part which is adapted to be in contact with the contact part of the male terminal includes a spring part.

4. The female terminal according to claim 1, wherein the insulating infilling body covers at least the contact part which is adapted to be in contact with the contact part of the male terminal, in the electrical connection part.

5. The female terminal according to claim 1, wherein the insulating infilling body covers an outer face of the electrical connection part.
